(19) United States
(12) Patent Application Publication
(10) Pub. No.: US 2019/0159508 A1
(43) Pub. Date: May 30, 2019

(54) Method of Coating Food Products

(71) Applicant: Frito-Lay North America, Inc., Plano, TX (US)

(72) Inventors: Jason BALLENGEE, Lewisville, TX (US); Justin A. FRENCH, Frisco, TX (US); Thomas A. TREZZA, Plano, TX (US)

(21) Appl. No.: 15/825,318

(22) Filed: Nov. 29, 2017

(51) Int. Cl. A23P 20/12; A23P 20/20; A21D 13/22

(52) U.S. Cl. CPC A23P 20/12; A23P 20/20; A21D 13/22; A23V 2002/00; A23V 2200/22; A23V 2300/24; A23V 2250/6422; A23V 2250/606; A23V 2250/61; A23V 2250/636; A23V 2250/6402; A23V 2250/6412; A23V 2250/5062

(57) ABSTRACT

A food product is coated with an edible, meltable powder. Upon melting, the powder-coated food product melts into a liquid coating on the food product. The meltable powder comprises a dry component free of starch and at least one of: a sorbitol dry component; an erythritol dry component; an arabitol dry component; a xylitol dry component; a lactitol dry component; a maltitol dry component; a combination of isomalt and sorbitol; a shellac dry component free of fatty acids; a soluble fiber dry component; a fructose dry component, a trehalose dry component, a glucose dry component, a maltose dry component, and an isomaltulose dry component. The polyols when present are free of polysaccharides. A number of food products can be coated with one or more of the dry components, which are subsequently melted to form a coating.

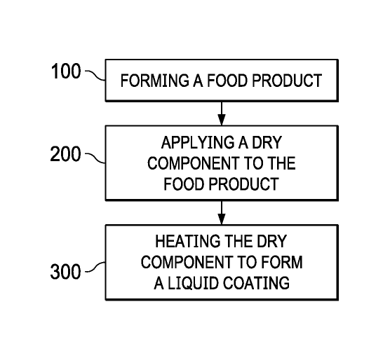

### BACKGROUND OF THE INVENTION

### Technical Field

The present invention relates to a method for coating a food product. More specifically, a method for coating a food product with a powder that melts upon heating.

### Description of Related Art

Current materials used to glaze or coat food products are often water-based and/or high in fat. Such materials are sometimes undesirable and can degrade the underlying food product. In addition, water-based solutions can require longer processes and/or higher costs in the form additional dryers or drying steps to remove the added water when shelf stable foods are desired. There is a need for a simple, cost-effective method of applying a glazing or coating to food products. Furthermore, adhering particulates to food products may also be desired.

### SUMMARY OF THE INVENTION

Below is a simplified summary of this disclosure meant to provide a basic understanding of some aspects of the products and methods described herein. This is not an exhaustive overview and is not intended to identify key or critical elements or to delineate the scope of the description. Its sole purpose is to present some concepts in a simplified form as a prelude to the more detailed description below.

A method of coating a food product comprises the steps of: forming a food product; applying a dry non-starch component onto the food product to form a layer comprising the dry non-starch component, said dry non-starch component comprising at least one of the following: a sorbitol dry component, the layer free of polysaccharides throughout the method; an erythritol dry component, the layer free of polysaccharides throughout the method; an arabitol dry component, the layer free of polysaccharides throughout the method; a xylitol dry component, the layer free of polysaccharides throughout the method; a lactitol dry component, the layer free of polysaccharides throughout the method; a maltitol dry component, the layer free of polysaccharides throughout the method; a combination of isomalt and the sorbitol in dry form, the layer free of polysaccharides throughout the method; a shellac dry component, the layer free of fatty acid components throughout the method; a soluble fiber dry component, the layer free of polyols; a fructose dry component; a trehalose dry component, glucose dry component; a maltose dry component; and an isomaltulose dry component; and heating the food product with said dry non-starch component to a temperature sufficient to melt the dry component, thereby forming a food product comprising a liquid coating. The method further comprises the step of cooling the food product comprising the liquid coating such that the coating solidifies in any embodiment described herein.

Other aspects, embodiments and features of the invention will become apparent in the following written detailed description and accompanying drawings.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawing, wherein the

FIGURE depicts one embodiment of the method described herein.

### DETAILED DESCRIPTION OF THE INVENTION

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein.

To the extent that a term or phrase is intended to have a special meaning, i.e., a meaning other than that understood by skilled artisans, such a special definition is expressly set forth in the specification in a definitional manner that directly and unequivocally provides the special definition for the term or phrase.

The terms “including,” “comprising,” “having,” and variations thereof mean “including but not limited to,” unless expressly specified otherwise. When used in the appended claims, in original and amended form, the term “comprising” is intended to be inclusive or open-ended and does not exclude any additional, unrecited element, method, step or material. The term “consisting of” excludes any element, step or material other than those specified in the claim. The terms “substantially consisting of” and “substantially consists of” means that any other components is only present as an impurity; however, any other component present is not intentionally added to the component or composition. For example, in some embodiments, a dry non-starch component substantially consisting of ‘x’ dry component comprises greater than about 70% of said ‘x’ dry component. In some embodiments, a dry non-starch component substantially consisting of ‘x’ dry component comprises greater than about 80% of said ‘x’ dry component. In some embodiments, a dry non-starch component substantially consisting of ‘x’ dry component comprises greater than about 90% of said ‘x’ dry component. In other embodiments, a dry non-starch component substantially consisting of ‘x’ dry component comprises greater than about 95% of said ‘x’ dry component.

Several embodiments of a method for coating a food product will now be described with reference to the FIGURE. Generally, the method comprises a first step of forming a food product 100. In some embodiments, the food product is formed by preparing a food product for application of the selected dry component. In some embodiments, the food product comprises a cooked food product. In some embodiments, the food product comprises a fabricated, mono-layered snack food product. In some embodiments, the food product comprises mono-layered finished snack products including without limitation popcorn, potato chips, tortilla chips, cookies, and crackers. In some embodiments, the food product comprises an intermediate, uncooked food product (i.e., raw and not fit for consumption without additional cooking or dehydrating steps). In some embodiments, the food product comprises an uncooked dough. In some embodiments, the food product comprises an uncooked, sheeted dough. In some embodiments, the food product comprises an uncooked, extruded dough. Suitable doughs may be derived or prepared from potatoes, corn, legumes including without limitation chickpeas, peas, lentils, and beans, and any combination thereof.

Following the forming of a food product 100, the applying of a dry non-starch component onto the food product 200 is performed. The applying step 200 comprises applying the dry non-starch component onto a food product to form a layer on at least one surface of the food product comprising the dry non-starch component. The applying step may comprise topical application, i.e., the applying to a surface of the food product.

As used herein, a “non-starch component” refers to an edible (i.e., safe to ingest) component that is completely free of any starch throughout the method for coating the food product.

The term “dry” generally refers to free-flowing dehydrated materials including without limitation powders, flakes, and granules, or any combination thereof, for example. In some embodiments, the dry components comprises a moisture content of less than about 20% moisture content. In some embodiments, the dry components comprises a moisture content of less than about 10% moisture content. In some embodiments, the dry components comprises a moisture content of less than about 5% moisture content. In some embodiments, the dry non-starch component comprises a powder free of (i.e., 0%) starch. In some embodiments, the dry non-starch component consists of a powder free of (i.e., 0%) starch.

The dry non-starch component comprises at least one of the following: a sorbitol dry component, the layer free of polysaccharides throughout the method; an erythritol dry component, the layer free of polysaccharides throughout the method; an arabitol dry component, the layer free of polysaccharides throughout the method; a xylitol dry component, the layer free of polysaccharides throughout the method; a lactitol dry component, the layer free of polysaccharides throughout the method; a maltitol dry component, the layer free of polysaccharides throughout the method; a combination of isomalt and the sorbitol, the layer free of polysaccharides throughout the method; a shellac dry component, the layer free of fatty acid components throughout the method; a soluble fiber dry component, the layer free of polyols; a fructose dry component; a glucose dry component; a maltose dry component; and an isomaltulose dry component. Unless otherwise specifically excluded from a dry component, the non-starch component may comprise any combination of the components recited in this paragraph in certain embodiments.

In some embodiments, the dry non-starch component substantially consists of a sugar alcohol throughout the method. In some embodiments, the sugar alcohol comprises sorbitol, erythritol, arabitol, xylitol, lactitol, maltitol, isomalt, and any combination of sorbitol, erythritol, arabitol, xylitol, lactitol, maltitol, and isomalt. In some embodiments, the dry non-starch component substantially consists of shellac throughout the method. In some embodiments, the dry non-starch component substantially consists of a soluble fiber throughout the method. In some embodiments, the dry non-starch dry component substantially consists of a sugar selected from the group consisting of fructose, trehalose, glucose, maltose, isomaltulose and any combination thereof. Other embodiments of the dry non-starch component are further described below.

In some embodiments, the layer of the dry non-starch component comprises a loading level of between about 2% to about 50%, per total weight of the food product. In some embodiments, the layer comprises a loading level of between about 8% to about 18%, per total weight of the food product. In some embodiments, the layer comprises a loading level of between about 5% to about 10%, per total weight of the food product.

In some embodiments, the dry non-starch component comprises a sorbitol dry component, the layer free of polysaccharides. In such embodiments, the dry non-starch component comprises at least about 5% of the sorbitol (polysaccharide-free) dry component, by weight of the total dry component. In some embodiments, the dry non-starch component comprises between about 5% to about 98% of the sorbitol dry component (i.e., about 5%, about 10%, about 15%, about 20%, about 25%, about 30%, about 35%, about 40%, about 45%, about 50%, about 55%, about 60%, about 65%, about 70%, about 75%, about 80%, about 85%, about 90, about 95%, about 98%, or any ranges between these recited percentages). For example, in some embodiments, the dry non-starch component comprises between about 40% to about 75% of the sorbitol dry component. In some embodiments, the dry non-starch component comprises between about 40% to about 60% of the sorbitol dry component. In one embodiment, the dry non-starch component substantially consists of sorbitol.

In some embodiments, the sorbitol dry component substantially consists of sorbitol; that is, any other component present being only an impurity. In some embodiments, the sorbitol dry component comprises greater than about 70% sorbitol. In some embodiments, the sorbitol dry component comprises greater than about 80% sorbitol. In some embodiments, the sorbitol dry component comprises greater than about 90% sorbitol. In some embodiments, the sorbitol dry component comprises greater than about 95% sorbitol.

In some embodiments, the dry non-starch component comprises an erythritol dry component, the layer free of polysaccharides. In some embodiments, the dry non-starch component comprises at least about 5% of the erythritol (polysaccharide-free) dry component, by weight of the total dry component. In some embodiments, the dry non-starch component comprises between about 5% to about 98% of the erythritol (polysaccharide-free) dry component (i.e., about 5%, about 10%, about 15%, about 20%, about 25%, about 30%, about 35%, about 40%, about 45%, about 50%, about 55%, about 60%, about 65%, about 70%, about 75%, about 80%, about 85%, about 90, about 95%, about 98%, or any ranges between these recited percentages). For example, in some embodiments, the dry non-starch component comprises between about 25% to about 55% of the erythritol dry component. In one embodiment, the dry non-starch component comprises about 55% erythritol dry component. In one embodiment, the dry non-starch component substantially consists of erythritol.

In some embodiments, the erythritol dry component substantially consists of erythritol; that is, any other component present being only an impurity. In some embodiments, the erythritol dry component comprises greater than about 70% erythritol. In some embodiments, the erythritol dry component comprises greater than about 80% erythritol. In some embodiments, the erythritol dry component comprises greater than about 90% erythritol. In some embodiments, the erythritol dry component comprises greater than about 95% erythritol.

In some embodiments, the dry non-starch component comprises an arabitol dry component, the layer free of polysaccharides. In some embodiments, the dry non-starch component comprises at least about 5% of the arabitol (polysaccharide-free) dry component, by weight of the total dry component. In some embodiments, the dry non-starch component comprises between about 5% to about 98% of the arabitol (polysaccharide-free) dry component (i.e., about 5%, about 10%, about 15%, about 20%, about 25%, about 30%, about 35%, about 40%, about 45%, about 50%, about 55%, about 60%, about 65%, about 70%, about 75%, about 80%, about 85%, about 90, about 95%, about 98%, or any ranges between these recited percentages). For example, in some embodiments, the dry non-starch component comprises between about 5% to about 95% of the arabitol dry component. In some embodiments, the dry non-starch component comprises between about 40% to about 70% of the arabitol dry component. In one embodiment, the dry non-starch component substantially consists of arabitol.

In some embodiments, the arabitol dry component substantially consists of arabitol; that is, any other component present being only an impurity. In some embodiments, the arabitol dry component comprises greater than about 70% arabitol. In some embodiments, the arabitol dry component comprises greater than about 80% arabitol. In some embodiments, the arabitol dry component comprises greater than about 90% arabitol. In some embodiments, the arabitol dry component comprises greater than about 95% arabitol.

In some embodiments, the dry non-starch component comprises a xylitol dry component, the layer free of polysaccharides. In some embodiments, the dry non-starch component comprises at least about 5% of the (polysaccharide-free) xylitol dry component, by weight of the total dry component. In some embodiments, the dry non-starch component comprises between about 5% to about 98% of the (polysaccharide-free) xylitol dry component (i.e., about 5%, about 10%, about 15%, about 20%, about 25%, about 30%, about 35%, about 40%, about 45%, about 50%, about 55%, about 60%, about 65%, about 70%, about 75%, about 80%, about 85%, about 90, about 95%, about 98%, or any ranges between these recited percentages). For example, in some embodiments, the dry non-starch component comprises between about 60% to about 75% of the xylitol dry component. In one embodiment, the dry non-starch component substantially consists of xylitol.

In some embodiments, the xylitol dry component substantially consists of xylitol; that is, any other component present being only an impurity. In some embodiments, the xylitol dry component comprises greater than about 70% xylitol. In some embodiments, the xylitol dry component comprises greater than about 80% xylitol. In some embodiments, the xylitol dry component comprises greater than about 90% xylitol. In some embodiments, the xylitol dry component comprises greater than about 95% xylitol.

In some embodiments, the dry non-starch component comprises arabitol and xylitol at a ratio ranging from about 5:95 to 95:5. In some embodiments, the dry non-starch component comprises arabitol and xylitol at a ratio of about 40:60.

In some embodiments, the dry non-starch component comprises a lactitol dry component, the layer free of polysaccharides. In some embodiments, the dry non-starch component comprises at least about 5% of the lactitol (polysaccharide free) dry component by weight of the total dry component. In some embodiments, the dry non-starch component comprises between about 5% to about 98% of the (polysaccharide-free) lactitol dry component (i.e., about 5%, about 10%, about 15%, about 20%, about 25%, about 30%, about 35%, about 40%, about 45%, about 50%, about 55%, about 60%, about 65%, about 70%, about 75%, about 80%, about 85%, about 90, about 95%, about 98%, or any ranges between these recited percentages). In one embodiment, the dry non-starch component substantially consists of lactitol.

In some embodiments, the lactitol dry component substantially consists of lactitol; that is, any other component present being only an impurity. In some embodiments, the lactitol dry component comprises greater than about 70% lactitol. In some embodiments, the lactitol dry component comprises greater than about 80% lactitol. In some embodiments, the lactitol dry component comprises greater than about 90% lactitol. In some embodiments, the lactitol dry component comprises greater than about 95% lactitol.

In some embodiments, the dry non-starch component comprises a maltitol dry component, the layer free of polysaccharides. In some embodiments, the dry non-starch component comprises at least about 5% of the (polysaccharide-free) maltitol dry component, by weight of the total dry non-starch component. In some embodiments, the dry non-starch component comprises between about 5% to about 98% of the (polysaccharide-free) maltitol dry component (i.e., about 5%, about 10%, about 15%, about 20%, about 25%, about 30%, about 35%, about 40%, about 45%, about 50%, about 55%, about 60%, about 65%, about 70%, about 75%, about 80%, about 85%, about 90, about 95%, about 98%, or any ranges between these recited percentages). In one embodiment, the dry non-starch component substantially consists of maltitol.

In some embodiments, the maltitol dry component substantially consists of maltitol; that is, any other component present being only an impurity. In some embodiments, the maltitol dry component comprises greater than about 70% maltitol. In some embodiments, the maltitol dry component comprises greater than about 80% maltitol. In some embodiments, the maltitol dry component comprises greater than about 90% maltitol. In some embodiments, the maltitol dry component comprises greater than about 95% maltitol.

In some embodiments, the dry non-starch component comprises a combination of isomalt and sorbitol, wherein both isomalt and sorbitol are in dry form, the layer free of polysaccharides. In some embodiments, the dry non-starch component comprises at least about 5% of the combination of isomalt and sorbitol (by weight of the total dry non-starch component). In some embodiments, the dry non-starch component comprises between about 5% to about 98% of the combination of isomalt and sorbitol (i.e., about 5%, about 10%, about 15%, about 20%, about 25%, about 30%, about 35%, about 40%, about 45%, about 50%, about 55%, about 60%, about 65%, about 70%, about 75%, about 80%, about 85%, about 90, about 95%, about 98%, or any ranges between these recited percentages). In one embodiment, the dry non-starch component substantially consists of isomalt and sorbitol. In some embodiments, the combination of isomalt and sorbitol is present at a weight ratio ranging of from about 95:5 to about 5:95. In some embodiments, the combination of isomalt and sorbitol is present at a weight ratio ranging of from about 80:20 to about 20:80. In one embodiment, the combination of isomalt and sorbitol is present at a weight ratio of about 60:40.

In some embodiments, the dry non-starch component comprises at least about 5% isomalt and one of: erythritol, trehalose, xylitol, or arabitol. In some embodiments, the dry non-starch component comprises isomalt and erythritol in a ratio ranging from about 5:95 to about 95:5. In some embodiments, the dry non-starch component comprises isomalt and erythritol at a ratio ranging from about 40:60 to about 60:40. In some embodiments, the dry non-starch component comprises isomalt and erythritol at a ratio of about 50:50. In some embodiments, the dry non-starch component comprises isomalt and trehalose at a ratio ranging from about 5:95 to about 95:5. In some embodiments, the dry non-starch component comprises isomalt and trehalose at a ratio of about 15:55. In some embodiments, the dry non-starch component comprises isomalt and xylitol at a ratio ranging from about 5:95 to about 95:5. In some embodiments, the dry non-starch component comprises isomalt and xylitol at a ratio of about 25:75. In some embodiments, the dry non-starch component comprises isomalt and arabitol at a ratio ranging from about 5:95 to about 95:5. In some embodiments, the dry non-starch component comprises isomalt and xylitol at a ratio of about 30:70.

It should be noted that in all embodiments wherein the dry non-starch component comprises a polyol, the dry non-starch component, the layer formed by the dry non-starch component, and the food product coatings are free of polysaccharides. In some embodiments, polyol dry components are also free of monosaccharides. In some embodiments, the dry non-starch component consists of one or more polyols.

In some embodiments, the dry non-starch component comprises a shellac dry component, the layer free of fatty acids. In such embodiments comprising shellac, the layer is further free of alcohols. In some embodiments, the dry non-starch component comprises at least about 5% shellac (fatty acid free), by total weight of the dry non-starch component. In some embodiments, the dry non-starch component comprises between about 5% to about 98% of the shellac dry component (i.e., about 5%, about 10%, about 15%, about 20%, about 25%, about 30%, about 35%, about 40%, about 45%, about 50%, about 55%, about 60%, about 65%, about 70%, about 75%, about 80%, about 85%, about 90, about 95%, about 98%, or any ranges between these recited percentages). In some embodiments, the dry non-starch component substantially consists of shellac.

In some embodiments, the shellac dry component substantially consists of shellac; that is, any other component present being only an impurity. In some embodiments, the shellac dry component comprises greater than 70% shellac. In some embodiments, the shellac dry component comprises greater than 80% shellac. In some embodiments, the shellac dry component comprises greater than 90% shellac. In some embodiments, the shellac dry component comprises greater than 95% shellac.

In some embodiments, the dry non-starch component comprises a soluble fiber dry component, the layer free of polyols throughout the method. In such embodiments, the dry non-starch component comprises at least about 5% soluble fiber (by weight of the total dry non-starch component). In some embodiments, the dry non-starch component comprises between about 5% to about 98% of the soluble fiber dry component (i.e., about 5%, about 10%, about 15%, about 20%, about 25%, about 30%, about 35%, about 40%, about 45%, about 50%, about 55%, about 60%, about 65%, about 70%, about 75%, about 80%, about 85%, about 90, about 95%, about 98%, or any ranges between these recited percentages). In one embodiment, the dry non-starch component substantially consists of soluble fiber. In some embodiments, the soluble fiber dry component comprises or substantially consists of inulin, the inulin being substantially free of sugar. That is, embodiments comprising inulin comprise only nominal amounts of sugars (i.e., less than about 15%). Some embodiments comprising inulin comprise less than about 10% sugars, which including without limitation glucose, fructose, galactose, sucrose, maltose, lactose, mannose, trehalose, xylose, and/or other sugars. In some embodiments comprising inulin, the inulin is further free of polyols. In some embodiments, the dry non-starch component substantially consists of an inulin powder. In embodiments comprising inulin, the inulin comprises a degree of polymerization of between 2 and 65.

In some embodiments, the dry non-starch component comprises a fructose dry component. In some embodiments, the dry non-starch component comprises at least about 5% fructose (by weight of the total dry non-starch component). In some embodiments, the dry non-starch component comprises between about 5% to about 98% of the fructose dry component (i.e., about 5%, about 10%, about 15%, about 20%, about 25%, about 30%, about 35%, about 40%, about 45%, about 50%, about 55%, about 60%, about 65%, about 70%, about 75%, about 80%, about 85%, about 90, about 95%, about 98%, or any ranges between these recited percentages). For example, in some embodiments, the dry non-starch component comprises between about 15% to about 55% of the fructose dry component. In some embodiments, the dry non-starch component comprises between about 25% to about 45% of the fructose dry component. In one embodiment, the dry non-starch component substantially consists of a fructose dry component.

In some embodiments, the fructose dry component substantially consists of fructose; that is, any other component present being only an impurity. In some embodiments, the fructose dry component comprises greater than about 70% fructose. In some embodiments, the fructose dry component comprises greater than about 80% fructose. In some embodiments, the fructose dry component comprises greater than about 90% fructose. In some embodiments, the fructose dry component comprises greater than about 95% fructose.

In some embodiments, the dry non-starch component comprises a glucose dry component. In some embodiments, the dry non-starch component comprises at least about 5% glucose, by total weight of the dry non-starch component. In some embodiments, the dry non-starch component comprises between about 5% to about 98% of the glucose dry component (i.e., about 5%, about 10%, about 15%, about 20%, about 25%, about 30%, about 35%, about 40%, about 45%, about 50%, about 55%, about 60%, about 65%, about 70%, about 75%, about 80%, about 85%, about 90, about 95%, about 98%, or any ranges between these recited percentages). For example, in some embodiments, the dry non-starch component comprises between about 15% to about 55% of the glucose dry component. In some embodiments, the dry non-starch component comprises between about 25% to about 45% of the glucose dry component. In one embodiment, the dry non-starch component substantially consists of a glucose dry component.

In some embodiments, the glucose dry component substantially consists of glucose; that is, any other component present being only an impurity. In some embodiments, the glucose dry component comprises greater than about 70% glucose. In some embodiments, the glucose dry component comprises greater than about 80% glucose. In some embodiments, the glucose dry component comprises greater than about 90% glucose. In some embodiments, the glucose dry component comprises greater than about 95% glucose.

In some embodiments, the dry non-starch component comprises a maltose dry component. In some embodiments, the dry non-starch component comprises at least about 5% maltose. In some embodiments, the dry non-starch component consists of a maltose dry component (by weight of the total dry non-starch component). In some embodiments, the dry non-starch component comprises between about 5% to about 98% maltose dry component (i.e., about 5%, about 10%, about 15%, about 20%, about 25%, about 30%, about 35%, about 40%, about 45%, about 50%, about 55%, about 60%, about 65%, about 70%, about 75%, about 80%, about 85%, about 90, about 95%, about 98%, or any ranges between these recited percentages). In one embodiment, the dry non-starch component substantially consists of a maltose dry component.

In some embodiments, the maltose dry component substantially consists of maltose; that is, any other component present being only an impurity. In some embodiments, the maltose dry component comprises greater than about 70% maltose. In some embodiments, the maltose dry component comprises greater than about 80% maltose. In some embodiments, the maltose dry component comprises greater than about 90% maltose. In some embodiments, the maltose dry component comprises greater than about 95% maltose.

In some embodiments, the dry non-starch component comprises an isomaltulose dry component. In some embodiments, the dry non-starch component comprises at least about 5% isomaltulose (by weight of the total dry non-starch component). In some embodiments, the dry non-starch component comprises between about 5% to about 98% isomaltulose dry component (i.e., about 5%, about 10%, about 15%, about 20%, about 25%, about 30%, about 35%, about 40%, about 45%, about 50%, about 55%, about 60%, about 65%, about 70%, about 75%, about 80%, about 85%, about 90, about 95%, about 98%, or any ranges between these recited percentages). In one embodiment, the dry non-starch component substantially consists of an isomaltulose dry component.

In some embodiments, the isomaltulose dry component substantially consists of isomaltulose; that is, any other component present being only an impurity. In some embodiments, the isomaltulose dry component comprises greater than about 70% isomaltulose. In some embodiments, the isomaltulose dry component comprises greater than about 80% isomaltulose. In some embodiments, the isomaltulose dry component comprises greater than about 90% isomaltulose. In some embodiments, the maltose dry component comprises greater than about 95% isomaltulose.

Other embodiments comprise, for example, the dry non-starch component comprises a combination of sorbitol with one of: trehalose, arabitol, erythritol, glucose, or fructose, the layer free of polysaccharides. In some embodiments, the dry non-starch component comprises sorbitol and trehalose at a ratio ranging from about 5:95 to about 95:5. In some embodiments, the dry non-starch component sorbitol and trehalose at a ratio of about 40:60. In some embodiments, the dry non-starch component comprises sorbitol and trehalose at a ratio ranging from about 5:95 to about 95:5. In some embodiments, the dry non-starch component sorbitol and trehalose at a ratio of about 40:60. In some embodiments, the dry non-starch component comprises sorbitol and arabitol at a ratio ranging from about 5:95 to about 95:5. In some embodiments, the dry non-starch component sorbitol and arabitol at a ratio of about 60:40. In some embodiments, the dry non-starch component comprises sorbitol and erythritol at a ratio ranging from about 5:95 to about 95:5. In some embodiments, the dry non-starch component sorbitol and erythritol at a ratio of about 75:25. In some embodiments, the dry non-starch component comprises sorbitol and glucose at a ratio ranging from about 5:95 to about 95:5. In some embodiments, the dry non-starch component sorbitol and glucose at a ratio of about 75:25. In some embodiments, the dry non-starch component comprises sorbitol and fructose at a ratio ranging from about 5:95 to about 95:5. In some embodiments, the dry non-starch component sorbitol and fructose at a ratio of about 75:25.

In some embodiments, the dry non-starch component comprises erythritol and one of: xylitol, glucose, or fructose, the layer free of polysaccharides. In some embodiments, the dry non-starch component comprises erythritol and xylitol at a ratio ranging from about 5:95 to about 95:5. In some embodiments, the dry non-starch component erythritol and xylitol at a ratio of about 25:75. In some embodiments, the dry non-starch component comprises erythritol and glucose at a ratio ranging from about 5:95 to about 95:5. In some embodiments, the dry non-starch component erythritol and glucose at a ratio of about 55:45. In some embodiments, the dry non-starch component comprises erythritol and fructose at a ratio ranging from about 5:95 to about 95:5. In some embodiments, the dry non-starch component erythritol and fructose at a ratio of about 55:45.

In any embodiment, the dry component may either comprise or consist of powder.

The applying step may comprise electrostatic powder coating, gravity feeding, gravity feeding assisted by electrostatic probe, pneumatic powder transport, scarf plate technology, powder spraying technology, or any combination thereof. In some embodiments, two or more powders are applied in series to create a layered structure. In some embodiments, two or more powders are applied simultaneously to the food product. In some embodiments, the dry non-starch component may be pre-conditioned with dry gas (i.e., air, nitrogen etc.) and/or heated prior to the applying step 200 to avoid moisture take up prior to the heating step 300. In some embodiments, a powder may be applied to a sheeted dough product and then another sheeted or half/food product may be added to achieve a laminated-type product.

In certain embodiments, to alter the melting temperature, the dry non-starch component may comprise a low molecular (i.e., less than 1000 g/mol) weight plasticizer, including without limitation glycerol, 1-2 propane-diol, 1-3 propane diol, triethylcitrate, sucrose esters, lectithn, glycerol monostearate, polyethylyene glycol, triacetin, and any combination thereof. Other common food or pharmaceutical plasticizers may also be used in some embodiments. In other embodiments, the melting temperature may be altered with a non-starch polymeric plasticizer with a weight range of 1000 to about 8000 g/mol.

In some embodiments, the dry non-starch component comprises a poorly miscible component. In some embodiments, the dry non-starch component comprises an amphiphilic material. Embodiments comprising either a poorly miscible component or an amphiphilic material may be used to create an opaque coating using the method described herein. In alternate embodiments, the dry non-starch component comprises a high miscible material and/or a material with a refractive index substantially similar to the dry non-starch component to create a clear coating using the method described herein. In some embodiments, the dry non-starch component comprises a high viscosity to create a porous, opaque coating using the method described herein. Certain embodiments of the dry non-starch component comprise a viscosity ranging from about 1,000 cP to about 200,000 cP. In some embodiments, the dry non-starch component comprises a viscosity ranging from about 10 cP to about 100,000 cP. In some embodiments, the dry non-starch component comprises a viscosity of about 50 cP to about 50,000 cP. In some embodiments, the dry non-starch component comprises a minimum viscosity of about 1,000 cP.

Referring back to the flow chart of the FIGURE, following applying step 200, heat is used to melt the layer comprising the dry non-starch component to form a food product comprising a liquid coating 300. Sufficient heating may be performed, for example, by way of one or more ovens, infrared heating, flame treatment, hot air treatments, or any other means known in the art. In some embodiments, the heating step 300 comprises an oven set at a temperature at or above the melting point of the dry non-starch component. In some embodiments, following the applying step 200, the food product is subject to an oven set to a temperature below the melting point of the dry non-starch component, followed by heating with an external heat source after exit from the oven, the external source comprising a temperature at or above the melting point of the dry non-starch component to cause melting. In some embodiments, heating 300 comprises heating the surface of the food product to a temperature sufficient to melt the dry component, followed by applying the dry non-starch component, thereby subjecting the dry non-starch component to residual heat and melting the dry non-starch component to produce the liquid coating. In some embodiments, heating 300 may comprise temperatures up to about 650° F. In some embodiments, heating 300 may comprise temperatures of about 100° F. to about 650° F. Heating may comprise baking an uncooked dough, in one embodiment, at temperatures of up to about 650° F.

In certain embodiments, the method comprising baking and dehydrating an intermediate food product, such as an uncooked dough, comprising a moisture content of between about 5% to about 30% by weight moisture, followed by subjecting the food product to a finishing oven to a final moisture content of less than about 4%. In some embodiments, the method further comprises the step of cooling the food product comprising the liquid coating such that the coating solidifies into a film. Active cooling may comprise, for example, cooling by air impingement after emerging from a heating step.

In some embodiments, the method further comprises a step of adding edible particulates onto the food product after the applying step 200 and prior to the heating step 300, the coating thereby adhering the edible particulates onto the food product. In some embodiments, edible particulates may range from about 0.001 mm to about 20 mm in diameter. In some embodiments, edible particulates may range from about 1 mm to about 5 mm in diameter. In some embodiments, the applying step 200 further comprises applying edible particulate to the food product prior to the heating step 300. In some embodiments, the method further comprises a step of adding edible particulates onto the food product simultaneous with the dry non-starch component after the heating step 300 and while the coating remains hot, the coating thereby adhering the particulates onto the food product. Such embodiments may comprise a step of pre-coating or otherwise combining the dry non-starch component onto the particulates. In some embodiments, the heating step 300 comprises melting the dry non-starch component to form a liquid coating and adding edible particulates to the liquid coating while hot, prior to the liquid coating hardening into a film. In some embodiments, particulates may be added after the applying step 200 and during the heating step 300. The particulates may comprise large particles (i.e., about 0.25 mm to about 20 mm in diameter) including without limitation nuts, seeds, vegetable bits (including without limitation red bell peppers granules, pepper corns, squash bits, asparagus bits, etc.), fruit pieces, meat pieces, cheese pieces, peanut butter bits, chocolate pieces, confectionary sprinkles, potato chip pieces, tortilla chip pieces, granola bits, seaweed pieces, edible plant pieces such as parsley flakes, and any combination thereof. In some embodiments, the particulates comprise a diameter of about 15 mm to about 20 mm. In some embodiments, the particulates may be thermally sensitive. In some embodiments comprising application of large particulates, a roller bar or the like may be used to provide mechanical pressure to press the large particulates into the dry non-starch layer or film and increase the surface area over which adhesive forces can act. In some embodiments, the method comprises a step of pressing particles of flavor into the layer. In some embodiments, large particles of flavor are added in an oven. Embodiments comprising application of large particulates may benefit from a cooling step comprising an insulating chamber to slow the cooling time of the dry non-starch component and thus provide an extended time period for the large particulates to adhere. In some embodiments, either the particulates or the dry non-starch component may be treated with plasma to increase adhesive forces, plasma treatment comprising exposure of the particulates and/or the dry non-starch component to an atmospheric plasma or plasma by-product.

Having described several embodiments of the method, it should be noted that when noted as free of a material “throughout the method,” the applied layer is free of said material, the resulting liquid coating following heating is free of the material, and the solidified coating or film is free of the material. As used herein, the terms “film” and “glaze” are used interchangeably to refer to a solidified coating on the food product.

During test runs, an uncooked dough product was heated in a first oven comprising four zones for no more than 6.5 minutes, followed by a finish dryer at temperatures ranging from about 225° F. to about 270° F. for between about 8 minutes to about 20 minutes. By way of example, a sheeted uncooked dough was formed, and a shellac powder was loaded at weight percentages of between about 5% to about 30%. The uncooked topped dough was subsequently introduced into a multi-zone, primary oven comprising a first oven zone at a temperature of about 475° F., a second oven zone of about 445° F., a third oven zone of about 450° F. and a fourth oven zone ranging from about 390° F. to about 450° F. The uncooked dough passed through the multi-zone oven in about 1.6 minutes. Upon exit, chili pepper flakes were added and the product then passed through a finish dryer at about 225° F. for about 8 minutes. Embodiments comprising sorbitol powder remained in the same primary oven (with consecutive zones of about 475° F., about 475° F., about 300° F., and 270° F.) for about 6.4 minutes until the sorbitol powder melted, forming a layer upon which pepper flakes were added, prior to passing through a finish dryer at a temperature of about 270° F. for about 20-minute dwell time. Those skilled in the art, armed with this disclosure, will recognize proper temperature and dwell times sufficient to melt the dry non-starch component and adhere any desired granules or flakes.

Having formed a film or glaze on the food product, such films can improve taste, texture, appearance, friability, or shelf-life. In some embodiments, the method and components described herein provide for a low fat coating of less than about 10% fat. In some embodiments, the low fat coating comprises less than about 1% fat. One additional benefit of this method is that it minimizes, and in many cases, eliminates, thermal treatment of the large particulate seasoning, which need not be subject to heated temperatures of the oven, resulting in improved product quality.

Unless otherwise specified, all percentages, parts and ratios as used herein refer to percentage, part, or ratio by weight of the total. Unless specifically set forth herein, the terms “a”, “an”, and “the” are not limited to one of such elements, but instead mean “at least one,” unless otherwise specified. The term “about” as used herein refers to the precise values as indicated as well as to values that are within statistical variations or measuring inaccuracies. In some embodiments, “about” encompasses values of +/−5% of the value indicated. In some embodiments, “about” encompasses values of +/−1% of the value indicated.

The methods disclosed herein may be suitably practiced in the absence of any element, limitation, or step that is not specifically disclosed herein. Similarly, specific snack food embodiments described herein may be obtained in the absence of any component not specifically described herein.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. For example, the range 1 to 10 also incorporates reference to all rational numbers within that range (i.e., 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

While this invention has been particularly shown and described with reference to several embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1) A method for coating a food product, said method comprising the steps of:
forming a food product;
applying a dry non-starch component onto the food product to form a layer comprising the dry non-starch component, wherein the dry non-starch component is free-flowing, said dry non-starch component comprising at least about 5% by weight of the total dry non-starch component of one of the following:
a sorbitol dry component, the layer free of polysaccharides throughout the method;
an erythritol dry component, the layer free of polysaccharides throughout the method;
an arabitol dry component, the layer free of polysaccharides throughout the method;
an xylitol dry component, the layer free of polysaccharides throughout the method;
a lactitol dry component, the layer free of polysaccharides throughout the method;
a maltitol dry component, the layer free of polysaccharides throughout the method
a combination of isomalt and the sorbitol, the layer free of polysaccharides throughout the method;
a shellac dry component, the layer free of fatty acid components throughout the method;
a soluble-fiber dry component, the layer free of polyols;
a fructose dry component;
a trehalose dry component;
a glucose dry component;
a maltose dry component; and
an isomaltulose dry component; and
heating the non-starch dry component to a temperature sufficient to melt the dry component, thereby forming a food product comprising a liquid coating.

2) The method of claim 1 wherein the food product comprises a fully cooked or partially cooked food product.

3) The method of claim 1 wherein the food product comprises an uncooked dough.

4) The method of claim 1 comprising the step of cooling the food product comprising the liquid coating such that the coating solidifies.

5) The method of claim 4 comprising the step of adding a plurality of edible large particulates prior to said heating step, the coating thereby adhering the edible large particulates onto the food product.

6) The method of claim 4 comprising the step of adding a plurality of edible large particulates onto the food product after the heating step, the coating thereby adhering the edible large particulates onto the food product.

7) The method of claim 1 comprising the combination of the isomalt and the sorbitol at a ratio of between about 95:5 and 5:95.

8) The method of claim 1 wherein the dry non-starch component comprises the sorbitol dry component.

9) The method of claim 1 wherein the dry non-starch component comprises the erythritol dry component.

10) The method of claim 1 wherein the dry non-starch component comprises at least about 5% by weight of the total dry non-starch component of one of the following: of the isomalt dry component and one of: erythritol, trehalose, xylitol, arabitol, glucose, or fructose.

11) The method of claim 1 wherein the dry non-starch component comprises the soluble fiber dry component, said soluble fiber consisting of inulin, the inulin free of sugar.

12) The method of claim 1 wherein the dry non-starch component comprises at least about 5% of one of: the fructose dry component, the glucose dry component, the trehalose dry component, the arabitol dry component, or the xylitol dry component.

13) The method of claim 1 wherein the dry non-starch component consists of sorbitol.

14) The method of claim 1 wherein the heating step comprises baking at temperatures of up to about 650° F. for up to about 30 minutes.

15) The method of claim 1 wherein the heating step comprises an oven followed by a secondary heat source.

16) The method of claim 1 wherein the heating step comprises more than one oven.

17) The method of claim 1 comprising a step of pressing particles of flavor into said layer.

18) The method of claim 1 wherein the heating step comprises an oven and large particles of flavor are added to the food product while in the oven.

19) The method of claim 1 wherein the applying step comprises electrostatic powder coating, gravity feeding, gravity feeding assisted by electrostatic probe, pneumatic powder transport, or any combination thereof.

20) The method of claim 1 wherein said applying step comprises large particles of flavor pre-coated with the dry non-starch component.

21) The method of claim 1 wherein the food product is derived from potatoes, corn, legumes, or any combination thereof.
